(19) United States
(12) Patent Application Publication
(10) Pub. No.: US 2012/0091125 A1
(43) Pub. Date: Apr. 19, 2012

(54) PIZZA PLATE COOKING APPARATUS

(76) Inventors: Eugene T. McGuinness, Oceanside, CA (US); Morgan McGuinness, La Palma, CA (US)

(21) Appl. No.: 13/236,197

(22) Filed: Sep. 19, 2011

Related U.S. Application Data
(60) Provisional application No. 61/403,764, filed on Sep. 21, 2010.

(51) Int. Cl. A47J 37/00

(52) U.S. Cl. 219/725

(57) ABSTRACT

Apparatus and method for supporting, baking and browning flat bread or a tortilla shell for use as a pizza pie base. The cooking device configured to cook sliced root vegetables in microwave oven. The pizza crust cooking device further including ridges with vent holes along the crest of the ridges that allow heat to flow to the food placed thereon. This results in very quick cooking giving the food crispy crunchy textures, using no fat oil or grease.

### CLAIM OF PRIORITY TO PRIOR APPLICATION

This application claims priority to provisional application having Ser. No. 61/403,764, entitled “Pizza Plate Micro Plate”, having a filing date of Sep. 21, 2010, which is herein incorporated by reference in its entirety.

### CROSS REFERENCES TO RELATED APPLICATIONS

This application is related to Ser. No. 11/742,869, entitled “Tortilla Cooking Apparatus”, having a filing date of May 1, 2007, which is herein incorporated by reference in its entirety.

### BACKGROUND

Eating and cooking tortillas, corn or flour, in their various forms be that as a taco, an enchilada, a tostada, a burrito, or any combinations of those and other forms of Mexican foods and Italian foods, such as pizzas, have become extremely popular. So popular that such is no longer limited to specialty Mexican restaurants or takeout pizza parlors. Many non-Mexican themed fast-food establishments have also embraced the tortilla and the pizza crust in its many forms.

Many large-chain supermarkets stock and sell various forms of tortilla shells and pizza crusts for the home shopper. Such tortilla shells or pizza crusts may be of the relatively fresh uncooked or partially cooked variety, pre-cooked or pre-formed variety, crisp variety, and the like. Pre-cooked and preformed may take the shape of a conventional U-shaped taco shell or flat to form a tostada to a fancy bowl-shape in which to place a salad, guacamole, frijoles (beans), or any other such treats or combinations thereof.

Uncooked tortilla shells are not generally suited for most Mexican-related meals and sometimes it is difficult to find pizza crusts for making individual pizza pies. The most well recognized means of cooking tortilla shells by a home user is by frying the soft tortilla shell in a frying pan having a suitable shortening in it. Frying for a short period of time will render the cooked shell pliable. Frying for longer periods will render the cooked shell crisp and brittle. How fried and for how long will all depend on the individual tastes of the end user. For those preferring the crisp shell over the softer shell, cooking the tortilla shells is difficult. One must cook them in the oil and shape them while cooking until the desired shaped is accomplished. All the while during this cooking process, the user must be careful to create and maintain the desired shape while cooking and not to break the tortilla shell in the process.

Many innovations in tortilla-cooking and pizza cooking devices and utensils have been made over the years due in large part to the rising popularity of foods involving the use of tortilla shells. Health-conscious diets caution against frying with shortenings and oils and other unhealthy ingredients in making taco shells or pizza crusts. Some have even resorted to baking the tortilla shells to their liking thereby eliminating any undesirable qualities occasioned by use of any shortening or oil. Baking, however, is more time-consuming and consumes considerable energy in the process. Cooking tortilla shells in the microwave oven makes it extremely difficult to form and generally tends to render the cooked shell soggy and unappealing. If the tortilla shell is of the flour variety, in addition, it will blister and generally deform.

The foregoing has outlined some of the more pertinent objects of the tortilla cooking device of the present invention. These objects should be construed to be merely illustrative of some of the more prominent features and applications of the tortilla cooking device of the present invention. Many other beneficial results can be attained by applying the disclosed tortilla cooking device of the present invention in a different manner or by modifying the tortilla cooking device of the present invention within the scope of the invention. Accordingly, other objects and a fuller understanding of the tortilla cooking device of the present invention may be had by referring to the summary of the tortilla cooking device of the present invention and the detailed description of the preferred embodiment in addition to the scope of the tortilla cooking device of the present invention defined by the claims taken in conjunction with the accompanying drawings.

### SUMMARY

The above-noted problems, among others, are overcome by the microwave cooking device of the present invention. In one example embodiment, a cooking apparatus and method is described herein for supporting, baking and browning of a flat bread portion (or tortilla) in a microwave oven that includes a plurality of ridges projecting up from a main surface of the device that serve as support members for supporting a food item. The ridges have vent holes along the crest of the ridges which allows heat to flow from both sides (above and below the main surface of the cooking device surface). This results in very quick cooking cycle thereby giving the food crispy crunchy textures, using no fat oil or grease. In a related embodiment, sliced root vegetables (such as potatoes and yucca) and others (such as carrots or broccoli) can also be cooked in microwave oven with the cooking apparatus described herein. In various embodiments described herein, the cooking device is configured in different shapes to accommodate other foods and microwave oven configurations such as a square, rectangle, oval or other geometric shapes. In yet another related embodiment, the vent holes on the plurality of ridges can be configured in different arrangements to modify the cooking characteristics of the cooking device. In a related embodiment, a plurality of vent holes or apertures is on each of the ridges the purpose of which is to allow full circulation of microwaves on the seated surface of the flatbread, pita or tortilla shell.

In a related embodiment, the construction material of the shaping member is modified to accommodate infrared radiation energy for cooking. In other related embodiments, the shaping member is configurable as described above to different shapes in order to generated different cooked tortilla or flatbread configurations including, but not limited to, flat, round, oval, triangular, u-shaped, round bowl with corrugated edges and the like.

The cooking system of described herein can also can cook into chips tortilla, potatoes, apples, carrots, by positioning them on the surface of the cooking plate which allows excellent exposure to heat. If one desires to add spray on flavors, there is no need to reposition the food.

The foregoing has outlined the more pertinent and important features of the tortilla cooking device of the present invention in order that the detailed description that follows may be better understood so the present contributions to the art may be more fully appreciated. Additional features of the tortilla cooking device of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the tortilla cooking device of the present invention. It also should be realized by those skilled in the art that such equivalent constructions and methods do not depart from the spirit and scope of the tortilla cooking device of the present invention as set forth in the appended claims.

### BRIEF DESCRIPTION OF THE DRAWINGS

For a fuller understanding of the nature and objects of the tortilla cooking device of the present invention, reference should be had to the following detailed description taken in conjunction with the accompanying drawings in which:

FIGS. 1A and 1B are a top and right side view, respectively, of a cooking device or apparatus according to the invention.

FIG. 2 is a perspective view of the cooking device or apparatus according to the invention.

FIG. 3 is a right side view of the cooking device or apparatus according to the invention.

### DETAILED DESCRIPTION

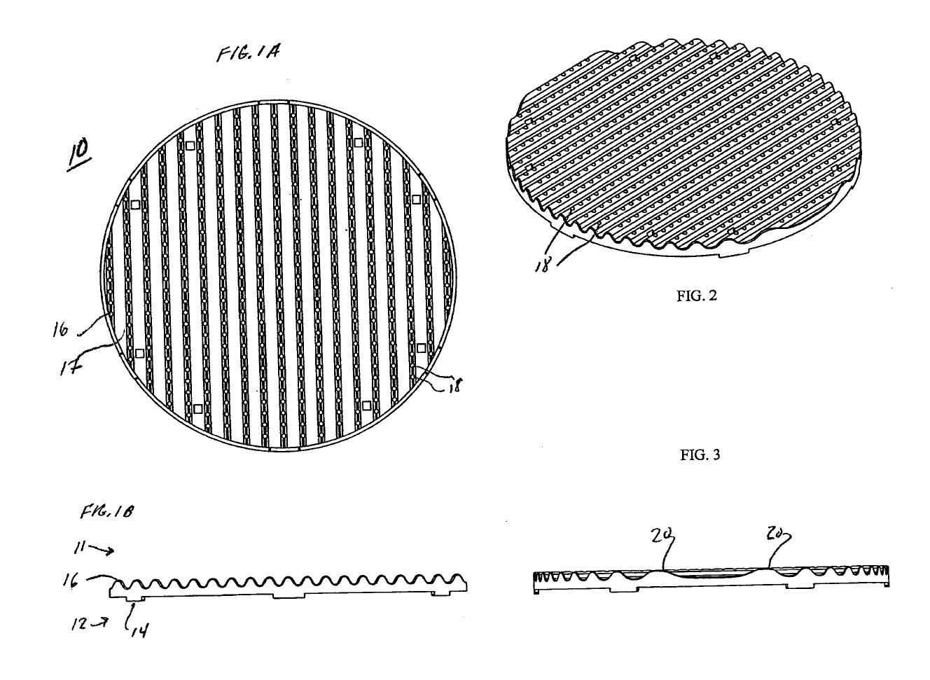

Referring now to the drawings in detail and in particular to FIGS. 1A-1B, 2 and 3, reference character 10 generally designates an example embodiment of a pizza plate cooking device of the present invention. This cooking device 10 is suited for cooking flatbread or tortilla shells for flat crust-based entrees. It has a base member 10A onto which a flatbread or tortilla shell is draped or placed for receiving base member 10A, with flatbread or tortilla shell, and placing into a conventional microwave oven for cooking.

Base member 10A of this embodiment has a first top side 11 and a second bottom side 12 that includes a series of support pegs 14. A plurality of ridges 16 are disposed on top side 11 and have formed in inverted U-shape rows. In a related embodiment, the rows have other shapes including but not limited to square, triangle or inverted V-shape, and oval. In this example embodiment, ridges 16 are relatively parallel to each other and include thereon a plurality of apertures or vent holes 18. In between each adjacent ridge there is located a valley or channel 17. Base member 10A, in this example embodiment, includes a raised set of ridges 20 along the perimeter that define an opening.

In this example embodiment, the shape of the perimeter of pizza plate or base member 10A is round with uniformly spaced rounded arched shape ridges 16 and “U” shaped valleys 17 running across the surface 11 with apertures 18 of equal size along the crest or peak on the ridges. In this example embodiment, the ridges collect heat from the underside and allow it to flow up apertures or “heat” vents along the crest of the ridges thereby cooking the selected food, in this example, giving the flatbread or a root vegetable a crispy crunchy texture. This cooking method also shortens the time it takes to the selected cook food. In this example embodiment, root vegetables such a potatoes, sweet potatoes, yucca as non-limiting examples, have a considerable amount of starch and tend to stick to cooking surfaces. The “heat” vents or apertures substantially reduce this problem.

In a related embodiment, cooking plate 10A is configured to cook into chips sliced or cut foods such as tortillas, potatoes, apples, carrots, and the like by positioning them on first side 11 and exposure them to the heat vents. If one desires to add spray on flavors it can be done without the need to reposition the food.

In a related embodiment, base member 10A is used to cook a pizza crust when cooking flatbread, pita bread or tortilla shell. Using a tortilla in this example, the tortilla becomes crispy and but not too crunchy. Other cooking methods over cook the tortilla to the point of being too brittle to serve as a pizza base for cooking a pizza pie. When the base is too brittle it does not make a good base because it breaks too easy. To ultimately avoid this problem the tortilla is cooked to a crispy crunchy texture first removed from the oven tomato sauce and toppings are then added and then the base is placed back in the oven; some the moisture from the toppings is reabsorbed into the base tortilla (or flatbread) resulting in a base that is cooked but not brittle.

In another example embodiment, plate 10A having these peaks and valleys render it well suited for cooking tortilla shells into tortilla chips, flatbread or pita bread into bread chips or pita chips. A tortilla (or flatbread or pita bread) would first by cut into desired shapes [triangular for instance], placed on plate 10A, then with cut-up tortilla pieces placed into a microwave oven and cooked to desired crispness. The peaks and valleys on base plate 10A serve to better circulate the microwaves for even cooking of the cut-up shells into uniformly crisp tortilla chips (or the pita or flatbread chips desired).

In this example embodiment, the shape of the perimeter of pizza plate or base member 10A is round with uniformly spaced rounded arched shape ridges 16 and “U” shaped valleys 17 running across the surface 11 with apertures 18 of equal size along the crest or peak on the ridges around the edges on the underside feet of equal size extend down. In various related embodiments, the outer perimeter of the base member has a shape that includes but is not limited to, a square, oval rectangle, and triangle. In addition, the ridges or peaks can have various shapes including but not limited to inverted V shape, rectangular, square and triangle. Further, the shape of each aperture or vent hole and the pattern of apertures are variable depending the on the desired cooking characteristics of the plate.

In a related embodiment, an added benefit of using tortillas in a microwave oven to make pizza is that it avoids the use of yeast, which some people are allergic to, which is usually present in ordinary pizza crust.

In yet another related embodiment, the support ridges of the cooking device provides the effect of sear or grilling marks on the foods that are being cooked, such as tortillas or hash browns, resulting in the appearance of “grilling” without any of drawbacks but making the foods more appetizing.

The present invention includes that contained in the present claims as well as that of the foregoing description. Although this pizza cooking device of the present invention has been described in its preferred forms with a certain degree of particularity, it is understood that the present invention of the preferred forms has been made only by way of example and numerous changes in the details of construction and combination and arrangement of parts and method steps may be resorted to without departing from the spirit and scope of the tortilla cooking device of the present invention. Accordingly, the scope of the tortilla cooking device of the present invention should be determined not by the embodiment[s] illustrated, but by the appended claims and their legal equivalents.

Applicant[s] have attempted to disclose all the embodiment[s] of the tortilla cooking device of the present invention that could be reasonably foreseen. It must be understood, however, that there may be unforeseeable insubstantial modifications to tortilla cooking device of the present invention that remain as equivalents and thereby falling within the scope of the tortilla cooking device of the present invention.

What is claimed is:

1. An apparatus for use in cooking flatbread in a microwave oven, the apparatus comprising:
a body having at least a width and a height, the body including alternating ridges and valleys disposed along at least a portion of the width of the body and extending transverse to the width of the body, each of the ridges and each of the valleys having two sides and a connecting portion connected to the two sides, wherein the protruding ridges collectively define the height of the body; and
wherein each of the ridges provides wholly within the ridge at least one aperture configured to allow steam to pass from the flatbread, when disposed on the body and cooked in a microwave oven, through the at least one aperture.

2. The apparatus of claim 1 wherein the body has a perimeter selected from the group consisted of a circle, square, a rectangle, a triangle and an oval.

3. The apparatus of claim 1 wherein each of the ridges provides a plurality of apertures disposed along a length of the ridge.

4. The apparatus of claim 3 wherein each of the ridges provides the apertures along the peak of the ridge.

5. The apparatus of claim 1 wherein the body consists of material selected from the group consisting of microwave-safe, disposable, infrared-safe, dishwasher safe, cardboard, paper, and wax-coated paper material.

6. An apparatus for use in cooking a single tortilla in a microwave oven, the apparatus comprising:
a body having at least a width and a height, the body including alternating ridges and valleys disposed along at least a portion of the width of the body and extending transverse to the width of the body configured to receive the single tortilla, each of the ridges and each of the valleys having two sides and a connecting portion connected to the two sides, wherein the protruding ridges collectively define the height of the body; and
wherein each of the ridges provides wholly within the ridge at least one aperture configured to allow steam to pass from the flatbread, when disposed on the body and cooked in a microwave oven, through the at least one aperture

7. The apparatus of claim 8 wherein both the ridges and the recesses extend transverse to the length of the body.

8. The apparatus of claim 7 wherein each of the ridges provides within the ridge at least one aperture configured to allow steam to pass from the single tortilla through the apparatus when the single tortilla is disposed on the body and cooked in a microwave oven.

9. The apparatus of claim 6 wherein the body consists of material selected from the group consisting of microwave-safe, disposable, infrared-safe, dishwasher safe, cardboard, paper, and wax-coated paper material.
